(19) United States
(12) Patent Application Publication
(10) Pub. No.: US 2026/0065411 A1
(43) Pub. Date: Mar. 5, 2026

(54) ADAPTIVE MEMORY MANAGEMENT SYSTEM FOR EFFICIENT TRAINING OF LARGE LANGUAGE MODELS

(71) Applicant: UNIVERSITY OF MASSACHUSETTS, Westborough, MA (US)

(72) Inventors: Hanmei Yang, Boston, MA (US); Tongping Liu, Boston, MA (US); Jin Zhou, Boston, MA (US); Hui Guan, Boston, MA (US)

(21) Appl. No.: 19/315,114

(22) Filed: Aug. 29, 2025

Related U.S. Application Data
(60) Provisional application No. 63/689,116, filed on Aug. 30, 2024.

(51) Int. Cl. G06T 1/20; G06T 1/60

(52) U.S. Cl. CPC G06T 1/20; G06T 1/60

(57) ABSTRACT

Various examples are provided related to adaptive memory management. In one example, a method includes determining a chunk size for organizing parameters, the chunk size determined based on execution order of parameters and selected to reduce memory waste; determining a swapping interval including one activation swapping block followed by an integer number of gradient checkpointing blocks, the swapping interval determined by dividing a time required to swap one transformer block by a computation time of the one transformer block; determining a number of persistent chunks and non-persistent chunks to offload model states from GPUs; determining a number of chunk buffers on the GPUs for prefetching and reusing the model states; determining a number of activation swapping blocks to offload activations from the GPUs; determining a number of transformer blocks to apply gradient checkpointing; and initiating a forward computation pass based upon the configurations. A backward computation pass can be performed.

### CROSS REFERENCE TO RELATED APPLICATIONS

This application claims priority to, and the benefit of, U.S. provisional application entitled “Adaptive Memory Management System for Efficient Training of Large Language Models” having Ser. No. 63/689,116, filed Aug. 30, 2024, which is hereby incorporated by reference in its entirety.

### STATEMENT REGARDING FEDERALLY SPONSORED RESEARCH OR DEVELOPMENT

This invention was made with government support under grant no. 2312396 awarded by the National Science Foundation. The Government has certain rights in the invention.

### BACKGROUND

Large Language Models (LLMs) have recently achieved remarkable success in various fields such as natural language processing, computer vision, and multi-modal processing. Inspired by the scaling law that the performance (e.g., perplexity) of LLMs often improves logarithmically with the number of parameters, there has been a trend towards increasing parameter size. For instance, the parameter size of GPT-like models has surged from 117 million in GPT-1 to 1,760 billion in GPT-4, a 15,000-fold increase over two years. The significant growth in parameter size leads to a substantial increase in memory demands. Specifically, each unit increase in parameters generally requires 16× more memory to store the model states (e.g., fp16 and fp32 parameters, fp16 gradients, fp32 momentum and variances), not to mention the increased memory demand for activations due to larger model sizes. Consequently, memory has become the dominant bottleneck in LLM training.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates examples of chunk operations in chunk-based model state management, in accordance with various embodiments of the present disclosure.

FIG. 2 illustrates an example of a block-wise activation management layout and memory usage trend, in accordance with various embodiments of the present disclosure.

FIGS. 3A and 3B are bar charts illustrating examples of maximum training throughput on four RTX 3090 GPUs and A100 GPUs, respectively, in accordance with various embodiments of the present disclosure.

FIGS. 4A and 4B are bar charts illustrating examples of scalability of performance on RTX 3090 GPUs for maximum throughput across different numbers of GPUs and step time breakdown for different batch sizes, respectively, in accordance with various embodiments of the present disclosure.

FIGS. 5A and 5B are bar charts illustrating examples of scalability of performance on A100 GPUs for maximum throughput across different numbers of GPUs and step time breakdown for different batch sizes, respectively, in accordance with various embodiments of the present disclosure.

FIGS. 6A and 6B include a bar chart and a plot illustrating examples of effectiveness of adaptive memory management on four RTX 3090 GPUs for runtime comparison of ProTrain with and without adaptive memory management and comparison of Protrain's actual and predicted runtime across various configurations, respectively, in accordance with various embodiments of the present disclosure.

FIG. 7 are bar charts illustrating examples of comparisons of predicted vs. actual runtime and peak memory usage for various models, respectively, in accordance with various embodiments of the present disclosure.

FIG. 8 is a bar chart illustrating effectiveness of dual-chunk system, block-wise activation management and parameter update overlapping on four RTX 3090 GPUs, in accordance with various embodiments of the present disclosure.

FIGS. 9A-9C are bar charts illustrating the impact of number of persistent chunks, chunk buffers, and swapping and gradient checkpointing blocks on performance of four RTX 3090 GPUs (10B GPT-2 BS=16), in accordance with various embodiments of the present disclosure.

FIG. 10 is a schematic block diagram illustrating an example of one or more computing device(s) that can be used to implement adaptive memory management, in accordance with various embodiments of the present disclosure.

FIG. 11 is a flow diagram illustrating an example of adaptive memory management that can be implemented by the computing device(s) of FIG. 10, in accordance with various embodiments of the present disclosure.

### DETAILED DESCRIPTION

Disclosed herein are various examples related to adaptive memory management. Reference will now be made in detail to the description of the embodiments as illustrated in the drawings, wherein like reference numbers indicate like parts throughout the several views.

Numerous memory management strategies have been proposed to address memory issues. For model states, a Zero Redundancy Optimizer (ZeRO) distributes them across multiple GPUs, leveraging aggregated memory capacity to accommodate large models in data parallelism. For activations, gradient checkpointing reduces memory consumption by discarding certain activations during the forward pass and recomputing them during the backward pass. Several techniques address memory savings for both model states and activations. Swapping can offload data to external memory sources such as CPU, memory or NVMe devices. Tensor parallelism can partition the computation of operators and distribute model states and activations across multiple devices. Pipeline parallelism can divide the model into stages, with each stage sequentially handling a portion of the model states and activations across different devices.

Data parallelism is widely used in distributed environments for its simplicity and scalability. Popular data-parallel frameworks, including DeepSpeed, Colossal-AI, and Fully Sharded Data Parallel (FSDP), adopt the aforementioned memory management techniques, such as ZeRO, CPU offloading, and gradient checkpointing. However, these frameworks share some common issues: (1) They only support coarse-grained control, such as a fixed parameter replication mode (ZeRO-2 or ZeRO-3), and binary options for offloading and gradient checkpointing. For instance, FSDP requires all model states to be either entirely offloaded to the CPU or kept on the GPU, and all transformer blocks either use gradient checkpointing or not at all. (2) They require significant manual effort to specify various configurations. In DeepSpeed, users must select the ZeRO optimization stage, configure offloading options (CPU or NVMe) for both parameters and optimizer states, and set multiple thresholds for parameter fetching and collective communications. Colossal-AI dynamically manages memory by moving data between CPU and GPU, requiring users to specify the non-model data ratio, which may lead to out-of-memory issues or reduced efficiency if misconfigured.

To solve these two prominent issues, ProTrain includes an adaptive memory management system that can manage memory intelligently based on LLM structure and available memory resource, without needing any manual intervention. The adaptiveness eliminates manual efforts in tuning numerous configurations, which often makes it challenging to identify setups that effectively adapt to both model and hardware. Furthermore, these baselines lack an automated tool for efficiently determining the optimal memory management configurations. By applying the same training configurations to different model architectures or the same architecture running on different platforms, non-adaptive systems will suffer from OOM errors due to inaccurate memory estimation or suboptimal training throughput from overly conservative memory management policies.

ProTrain can handle memory, computation, and 10 as follows: (1) To reduce memory consumption, ProTrain can adaptively decide whether to use offloading or gradient checkpointing, determine the amount of model states and activations to offload and the number of transformer blocks to apply gradient checkpointing, all without user inputs. (2) For computation, ProTrain can keep forward/backward computation on the graphics processing unit (GPU) for efficiency, while dynamically determining the portion of parameter updates to be performed on the central processing unit (CPU) and GPU. Additionally, ProTrain can perform CPU parameter updates concurrently with backward computation on the GPU to hide the overhead of CPU updates. (3) ProTrain can overlap 10 communication with computation by proactively prefetching future parameters during forward/backward computation, parallelizing gradient offloading with backward computation, and swapping activations only when the overhead can be hidden by computation.

To achieve the above-mentioned adaptive memory management, ProTrain includes a Chunk-Based Model State Management system that can organize model states into uniformly sized chunks, and further introduce persistent chunks and chunk buffers to minimize unnecessary data copying and reduce dynamic memory allocations. ProTrain can also utilize Block-Wise Activation Management to handle activations at the transformer block level, performing swapping or gradient checkpointing as needed for each block. To hide the swapping overhead, ProTrain can apply interleaved swapping and checkpointing, where each block of swapping is typically followed by multiple blocks of checkpointing. This ensures that ProTrain's swapping reduces memory usage without compromising performance. These capabilities of ProTrain can be built on its Memory-Aware Runtime Profiler, which can estimate runtime overhead and memory requirements, enabling efficient orchestration of computation, memory and 10.

In experiments, ProTrain and other popular training frameworks (e.g., DeepSpeed, Colossal-AI, FSDP) were run on various models such as GPT-2, OPT, Mistral, and LLaMA. On RTX 3090 GPUs, ProTrain trained models up to 2× larger than DeepSpeed and 1.2× larger than Colossal-AI. It achieved an average of 1.8× to 2.8× higher training throughput compared to other frameworks. On A100 GPUs, ProTrain trained models up to 7× larger than FSDP, with 1.4× to 2.3× higher throughput than other frameworks. ProTrain also demonstrated excellent scalability with increasing GPUs or batch sizes. These results highlight ProTrain's superior memory management and efficiency across different hardware setups, making it an excellent choice for large-scale model training.

Deep Learning Model Training. Training deep learning models involves a repetitive three-stage process across multiple iterations and epochs. The stages include forward propagation (FWD), where a batch of training samples is passed to the model to compute the loss; backward propagation (BWD), which calculates gradients by backpropagating the loss through the model; and parameter updating (OPTIM), where the gradients are used to update model parameters via an optimizer. For the training of large models, it is a common practice to adopt mixed-precision training, which uses reduced precision data types for FWD and BWD, while maintaining higher precision for OPTIM to ensure accuracy.

Memory consumption during training primarily comes from two sources: model states and residual states. Model states include parameters, gradients, and optimizer states while residual states comprise activations and temporary buffers. The computational complexity of the FWD and BWD stages scales with model size and batch size, necessitating their execution on GPUs due to the intensive computational demands. In contrast, the OPTIM stage involves simpler operations and can be efficiently offloaded to the CPU, which brings significant GPU memory savings by allocating memory-intensive optimizer states on the CPU.

ZeRO Techniques. The Zero Redundancy Optimizer (ZeRO) is a memory optimization technique for large-scale distributed model training. It enhances traditional data parallelism by distributing model states across multiple GPUs, thus mitigating memory bottlenecks. ZeRO operates in three stages: ZeRO-1 partitions optimizer states across GPUs; ZeRO-2 extends this by also distributing gradients; and ZeRO-3 further divides the parameters, which are needed to be gathered before forward/backward computation.

The ZeRO techniques have been integrated into state-of-the-art frameworks such as DeepSpeed, FSDP, and Colossal-AI, each differing in their parameter organization to optimize bandwidth utilization. Unlike DeepSpeed and FSDP, which require manual configuration for parameter grouping, Colossal-AI automatically groups parameters into chunks and dynamically adjusts their size according to the model's scale. This chunk-based method is also adopted in ProTrain, as it not only enhances bandwidth efficiency but also enables more advanced management of model states as will be discussed.

### ProTrain Design

ProTrain comprises three core components: a fine-grained memory management module that includes Chunk-Based Management for model states and Block-Wise Management for activations, a Memory-Aware Runtime Profiler that collects model runtime and memory information, and an Adaptive Memory Management module that identifies and applies the optimal configuration for better performance and hardware utilization.

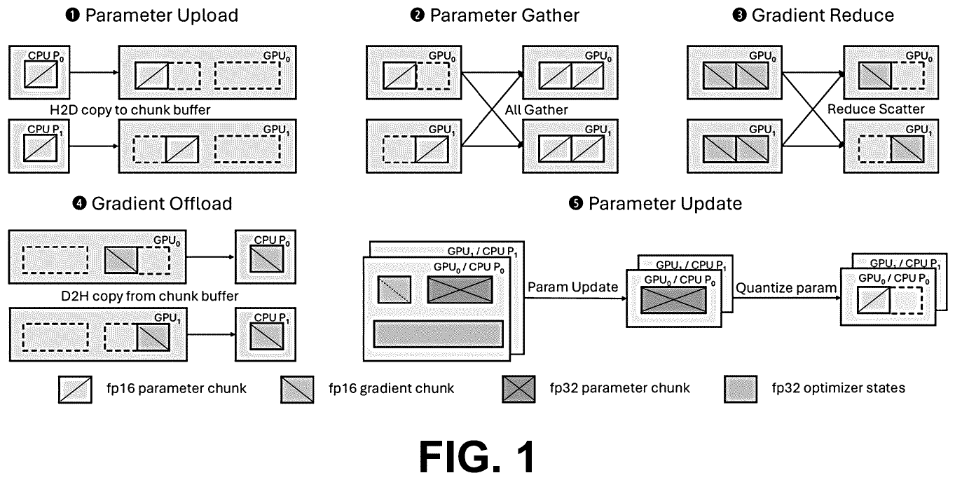

Chunk-Based Model State Management. ProTrain includes a new chunk-based management approach to organize model states into uniformly sized chunks. FIG. 1 outlines five operations involved with chunks. In distributed training, each chunk is evenly divided and distributed across GPUs, with each GPU holding one shard. Before each forward or backward pass, an all-gather operation is performed to collect shards from all GPUs, assembling them into a complete parameter chunk for use in the upcoming computations ( [symbol] ). In the backward pass, ProTrain reuses the parameter chunks to store the computed gradients, thus reducing memory usage. Once the gradients have completely replaced the parameters within a chunk, a reduce-scatter operation averages the gradients across GPUs ( [symbol] ). When GPU memory is insufficient, ProTrain offloads model states to the CPU. Consequently, parameter chunks must be uploaded to the GPU before gathering ( [symbol] ), and gradient chunks are offloaded to the CPU after gradient reduce ( [symbol] ). Lastly, parameter update happens on either GPU or CPU depending on the location of model states ( [symbol] ).

Fully offloading all parameters, as seen in FSDP, often results in inefficient GPU memory utilization and high data transfer overhead. To address this, ProTrain includes a dual-chunk system comprising persistent and non-persistent chunks. Persistent chunks permanently store model states on GPU, eliminating data transfers and enabling direct GPU parameter updates. Conversely, non-persistent chunks are stored on CPU memory, with parameters uploaded to the GPU for computation and gradients offloaded back to the CPU for parameter update. Although CPU update is generally slower than GPU update, ProTrain leverages the observation that the CPU is typically idle during GPU's backward computations to perform CPU parameter update concurrently, effectively hiding the high CPU update overhead and enhancing overall hardware utilization.

Building on the dual-chunk system, ProTrain can utilize a persistent-chunk-first strategy that prioritizes using persistent chunks for early-executed layers. This strategy not only reduces start-up latency by eliminating parameter uploads but also enhances efficiency by enabling GPU parameter update, as these early-executed layers are processed last in the backward pass, leaving fewer computations to overlap with CPU updates. Additionally, ProTrain can introduce pre-allocated chunk buffers for non-persistent chunks to avoid frequent memory allocations and deallocations. At least three buffers are utilized: one for prefetching parameters, one for participating in computations, and one for offloading gradients. These buffers can also act as caches, enabling the reuse of parameters loaded during the forward pass at the beginning of the backward pass, thus eliminating the need for data transfers.

Furthermore, ProTrain can organize model parameters according to their execution order at runtime, rather than the initialization order used in Colossal-AI. This arrangement reduces the need to frequently load and unload chunks due to memory constraints, thereby minimizing unnecessary back-and-forth accesses that can degrade performance. For transformer models, ProTrain can group parameters from the same block into one chunk, which can minimize memory accesses, especially when using gradient checkpointing that requires revisiting parameters in reverse during the backward pass. By optimizing chunk organization, ProTrain can simplify the balance between performance and memory usage to determine the optimal number of persistent chunks and chunk buffers, paving the way for adaptive memory management, as detailed below.

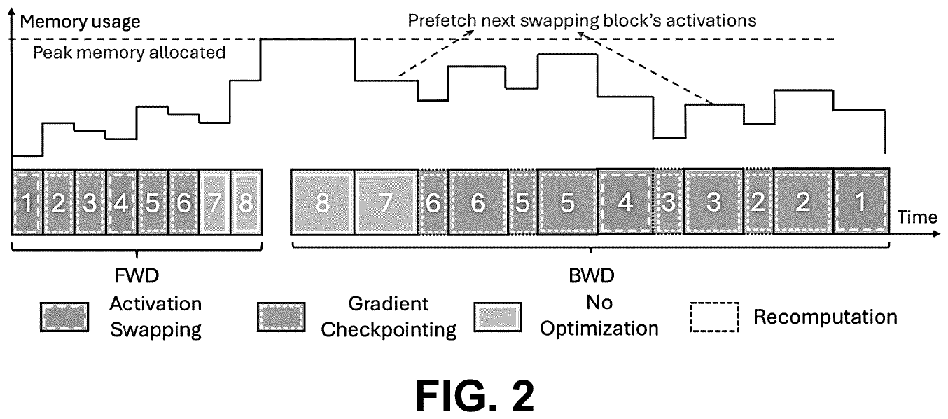

Block-Wise Activation Management. ProTrain includes a novel block-wise management for activations that seamlessly integrates activation swapping and gradient checkpointing to optimize memory usage without compromising performance. In ProTrain, the activation of each transformer block belongs to one of three types: swapping, checkpointing, or neither. Swapping indicates that the block will be swapped out, and checkpointing means that the entire block will be recomputed by saving the input tensor of the block. FIG. 2 illustrates an example of the block-wise activation management policy for a transformer with 8 blocks. Each block corresponds to a transformer block and uses one of the three memory management configurations: swapping, gradient checkpointing, no optimization (neither swapping nor checkpointing), in handling activations. The time for the backward pass (BWD) is typically twice that of the forward pass (FWD). For gradient checkpointed blocks, recomputation is necessary (similar duration of the forward), but swapping blocks do not need such time. Each swapping block is followed with multiple blocks of gradient checkpointing. This design hides the communication overhead from activation swapping and prevents activations waiting to be swapped accumulating and causing OOM error.

In this example, ProTrain automatically identifies the best strategy: using 2 blocks for swapping and 4 blocks for gradient checkpointing, with the swapping interval set to 3. After determining the quantities, block 1 and 4 are assigned for swapping, block 2, 3, 5, and 6 for checkpointing, and the remaining blocks do not use any optimizations. The last few blocks do not use optimizations because they perform backward pass sooner, which (1) does not allow sufficient time to swap in activations, and (2) enables the rapid consumption of numerous activations, freeing up space for swapping. Prefetching for swapping blocks begins as soon as sufficient memory becomes available. Memory usage can be seen in the top part, where the last block of the forward reaches the maximum memory usage in FIG. 2. Overall, ProTrain ensures the best memory management policy under the setting of “batch size”. Note that this selection is made automatically based on the accurate estimators for peak memory and runtime so that it adapts to the model architecture and hardware. Although the integration of both swapping and gradient checkpointing has been proposed before, ProTrain's activation management has the following significant difference.

First, ProTrain manages activations at the block level, instead of at the tensor granularity. Although managing at the tensor level offers greater flexibility, it is less necessary due to the predictable execution patterns of transformers. Existing gradient checkpointing mechanisms typically checkpoint the entire transformer block, necessitating the recomputation of all activations within that block. ProTrain's approach integrates more seamlessly with these mechanisms but differs in its ability to selectively apply gradient checkpointing to specific parts of blocks, rather than uniformly to all blocks, providing more fine-grained and efficient activation management.

Second, ProTrain can utilize an interleaved swapping and checkpointing strategy to improve training efficiency. Typically, ProTrain uses activation swapping for the first transformer block and applies gradient checkpointing to subsequent blocks in an interleaved manner. The swapping interval is carefully chosen to match the computation time with the time needed to swap out a block. If there is enough memory to hold multiple blocks simultaneously, these blocks are processed without swapping or checkpointing. As shown in FIG. 2, this interleaved strategy minimizes peak memory usage. During the forward pass, only one swapping block's activation accumulates at a time due to the swapping interval. In the backward pass, blocks without optimization are processed first, consuming activations and freeing memory for subsequent checkpointing and swapping. ProTrain can also optimize activation prefetching by balancing early prefetching to hide communication delays against the risk of memory overflow. Prefetching starts only when sufficient memory is confirmed, with activations grouped into manageable chunks for better bandwidth utilization.

Memory-Aware Runtime Profiling. ProTrain includes a memory-aware runtime profiler to provide precise insights into memory requirements, even with limited memory capacity. The profiler can adopt model-wise runtime profiling to address the underestimation of memory demands often seen with static profiling and layer-wise runtime profiling, which do not account for unhookable operators and temporary buffers. Specifically, ProTrain can register hooks for each hookable operation and analyze memory changes between consecutive hookable operations to infer the memory usage of unhookable operations. Additionally, by registering hooks before and after each hookable operation, ProTrain can monitor peak memory changes to understand the memory usage of temporary buffers. To profile very large models without out-of-memory issues, ProTrain can devise a drop-and-regenerate method that keeps only the current layer's data in GPU memory, dropping other data (e.g., parameters, gradients, activations) and regenerating them as needed. While this method saves memory, it also alters the total memory usage. ProTrain's profiler can use hooks to monitor memory changes and peak usage before and during operations, making it memory-aware. By combining these observed memory fluctuations with the known sizes of discarded tensors, it can precisely predict memory demands under various memory management techniques, as detailed below.

The profiler can also track the execution time of each operator. Similar to memory profiling, the intervals between hookable operators can be leverage to estimate the execution times of unhookable ones. Additionally, the profiler can collect detailed hardware metrics, including memory transfer bandwidth and collective communication operation durations, under both isolated and overlapping scenarios. This holistic data collection accurately reflects actual system performance and facilitates the prediction of performance across various conditions, enabling adaptive memory management tailored to specific models and hardware.

Adaptive Memory Management. ProTrain's Adaptive Memory Management comprises three components: Chunk-Aware Runtime Estimator, Peak Memory Usage Estimator, and Optimal Configuration Search. These components work together to select the configuration that minimizes runtime while ensuring memory demands do not exceed hardware limits.

Chunk-Aware Runtime Estimator. ProTrain's runtime estimator analyzes computation and communication times at the chunk level, aligning with its design where operations are primarily chunk-based, as depicted in FIG. 1. It aggregates individual operator runtimes within a chunk for forward computation and additionally includes recomputation times for checkpointed blocks during backward computation, leveraging the block-to-chunk mapping, which benefits from the design that consolidates each block's parameters into a single chunk. For communication, ProTrain uses chunk size and transfer bandwidth to estimate upload and offload times, and models collective communication overheads for chunk gather and reduce operations. The estimation of communication overheads considers the overlapping scenarios under the current configuration. For example, when activation swapping is enabled, the transfer throughput for parameter prefetching can be affected. The computation of one chunk overlaps with the prefetch of the next chunk and the offload of the previous chunk. By comparing these overheads, the estimator determines whether a chunk is compute-bound or communication-bound, using the larger value as the chunk's runtime estimate. Each chunk's forward and backward runtime estimates are aggregated to calculate the total forward (T_{FWD}) and backward runtime (T_{BWD}) for one iteration. For persistent chunks using GPU parameter updates (T_{GPU_OPTIM}), the FusedAdam optimizer can be utilized with predictable runtime based on parameter size. For non-persistent chunks with CPU parameter can updates (T_{CPU_OPTIM}), the estimator checks if updates can fully overlap with remaining computations, as detailed in Equation (1).

$${T}_{Iteration} = {T}_{FWD} + max \{ {T}_{BWD} + {T}_{GPU\_OPTIM} , {T}_{CPU\_OPTIM} \} \qquad ( 1 )$$

Peak Memory Usage Estimator. As discussed in the Memory-Aware Runtime Profiling Section above, the profiler captures both current (C) and peak (P) memory variations before (PriorOpᵢ) and during (Opᵢ) operators, focusing on the backward pass where peak memory usage typically occurs. Initially, model states are excluded and the current memory (M_{Current}) set to the sum of forward memory usage and activation memory (A_{Op}_{ᵢ}) for all operators, accounting for the drop of activations during profiling. The current and peak memory are then iteratively calculated for each layer to obtain the baseline peak memory (M_{Peak}), as shown in Equations (2) and (3).

$${M}_{Current} = {M}_{Current} + {C}_{{PriorOp}_{i}} + {C}_{{Op}_{i}} - {A}_{{Op}_{i}} \qquad ( 2 )$$

$${M}_{Peak} = max \{ {M}_{Peak} , {M}_{Current} + {P}_{{PriorOp}_{i}} , {M}_{Current} + {C}_{{PriorOp}_{i}} + {P}_{{Op}_{i}} \} \qquad ( 3 )$$

For model states, memory usage is predictable with chunk-based management, determined by chunk size, the number of persistent chunks and chunk buffers. Memory savings from block-wise activation management are calculated based on the number of blocks designated for swapping and checkpointing. The final peak memory demand combines baseline peak memory with model states' memory and deducts savings from block-wise activation management. This approach provides a precise and comprehensive overview of memory requirements, addressing challenges in memory estimation present in existing works.

Optimal Configuration Search. In ProTrain, adjustable configurations include the number of persistent chunks Nₚₑᵣₛᵢₛₜ, chunk buffers N_{buffer}, swapping blocks N_{swap}, and checkpointing blocks N_{checkpoint}. These configurations are constrained such that their sum does not exceed the total number of chunks or blocks. Increasing persistent chunks and chunk buffers typically yields performance gains due to reduced need for parameter prefetching, though this benefit is offset by increased GPU memory usage. Conversely, more swapping and checkpointing can lead to substantial memory savings, but swapping may interfere with parameter prefetching due to limited bandwidth and checkpointing introduces extra recomputation overhead. It is insufficient to optimize these settings in isolation, as an improvement in one configuration may lead to suboptimal performance elsewhere. Therefore, a holistic consideration of all configurations is needed to evaluate their combined impact on performance and memory usage.

The configuration space in ProTrain is structured and finite, allowing for an exhaustive search of all possible configurations. Even then, ProTrain employs specific pruning strategies to further reduce the search space. For instance, the maximum number of swappable blocks is limited by the swapping interval to ensure they overlap with forward computations. During the backward phase, the system monitors bandwidth usage for chunk prefetching to ensure sufficient bandwidth remains for activation prefetching. Additionally, as configurations are traversed from smallest to largest, any swapping and checkpointing combination that results in memory overflow is immediately discarded, and subsequent iterations involving this combination are skipped. For each viable configuration, ProTrain's runtime estimator predicts the runtime, selecting the one with the shortest runtime as the final setup.

### Implementation Details

ProTrain was implemented using Python language, with a total of 6,000 lines of code. It provided very simple APIs that were convenient to use, which only needed less than 5 lines of code change on top of the training script for PyTorch. Different from existing work, ProTrain needed almost zero manual effort of configuration due to its adaptive memory management design.

Adaptive Chunk Size. ProTrain employs a dynamic search mechanism to determine the optimal chunk size for model training, which organizes parameters according to their execution order and ensures that all parameters within a block are grouped in a single chunk. For transformers which often share parameters across layers, ProTrain uses the parameter's first occurrence as the ordering criterion. To find the most efficient chunk size, ProTrain conducts a grid search, simulating memory waste across various chunk sizes to identify the size that minimizes waste.

Memory Optimizations. Proactive Memory Allocation. ProTrain preallocates memory for tensors that persist until training completes, including early allocation of persistent chunks for parameters and optimizer states, as well as GPU chunk buffers. This proactive strategy reduces the number of memory allocations and mitigates fragmentation by grouping long-lived tensors together, ensuring a more organized and efficient memory layout.

Single-Stream Memory Allocation. ProTrain unifies memory allocations within the default stream to improve memory utilization. PyTorch's allocator adopts a multi-heap design where each stream has its own heap, limiting cross-heap memory reuse and necessitating the use of record_stream( ) to ensure correctness. By using a single stream for all allocations and directly managing deallocation synchronization itself, it can effectively prevent misuse and reallocation conflicts, thereby improve memory efficiency.

Customized Pinned Memory Allocator. It was observed that the default pinned memory allocator (CUDAHostAllocator) often over-allocates by rounding up to the nearest power of two, leading to significant memory waste. To address this inefficiency, ProTrain utilizes a customized pinned memory allocator that leverages insights from adaptive memory management to precisely determine pinned memory requirements, providing finer control and avoiding the excessive memory reservation of the default allocator.

Swapping and Recomputation. Swapping is an employed technique which leverages external memory such as CPU memory to offload tensors, thereby expanding the available memory for training. Traditional swapping methods mainly focus on offloading activations, e.g., SwapAdvisor extends it to parameters and ZeRO-offload further extends it to optimizer states. Recomputation, also known as gradient checkpointing, is another technique that trades additional recompute time during backward pass for reduced memory usage of activations. An initial study focused on homogeneous sequential networks, and subsequent studies extended its applicability to heterogeneous networks. Considering the scale and complexity of Transformers, which often contain numerous layers, previous approaches become less efficient. Rockmate optimizes the plan generation by partitioning models into fine-grained blocks. NVIDIA further proposes selective activation recomputation which checkpoints and recomputes parts of layers. To get the best of both worlds, some works jointly optimize swapping and recomputation, whereas ProTrain differentiates itself by tailoring the fit to the specific structure of transformers.

Parallelization Techniques. Training large models often requires multiple GPUs to distribute memory and computation loads effectively. This approach utilizes three types of parallelisms: Data Parallelism (DP), which distributes input data across devices; Tensor Parallelism (TP), partitioning tensors within an operator among multiple GPUs; and Pipeline Parallelism (PP), which divides the model into subgraphs assigned to different devices. For DP, Zero Redundancy Optimizer (ZeRO) is introduced to enhance memory efficiency by partitioning and distributing the optimizer states, gradients and parameters across various devices, significantly reducing memory demands. In the presented examples, the focus is on Data Parallelism using ZeRO.

Overlapping Computation and Communication. There are numerous works on overlapping computation and communication, with many studies focusing on substituting, splitting, and scheduling complex operators to achieve fine-grained overlapping. CoCoNet enhances lower-level operator optimization, while Centauri extends this to graph-level scheduling, offering a more hierarchical abstraction. Despite these advances, most research focuses on the optimization of collective communication operations in distributed cases. However, ProTrain also considers the communication between CPU and GPU under limited GPU memory conditions, making it orthogonal to existing research.

Training Frameworks for Transformers. In response to the growing demand for efficient training of transformers, several specialized frameworks have been developed, each offering unique features and optimizations. DeepSpeed by Microsoft enhances training efficiency through ZeRO series techniques and supports various parallelism strategies, swapping, and recomputation. Colossal-AI from HPC-AI Tech, which offering similar features, distinguishes itself with a chunk-based memory management approach, which the work adopts. Megatron-LM by NVIDIA, on the other hand, specializes in model parallelism. These frameworks are designed for large-scale transformer training, complemented by academic efforts to facilitate training on smaller systems.

### Experimental Setup

Workloads. The tested models includes GPT-2, OPT, Mistral, and LLaMA. By varying the hidden dimension, the number of transformer blocks, and the number of attention heads, models were generated with different parameter sizes, with the model configuration used in the experiment detailed in the table below. The sequence length is set to 1024 by default.

Model Configuration

| | | Hidden | | # of |
|---|---|---|---|---|
| Model | Parameter Size | Size | # of Layers | Heads |
| Mistral | 7B | 4096 | 32 | 32 |
| GPT-2 | 10B | 4096 | 48 | 32 |
| OPT, LLaMA | 13B | 5120 | 40 | 40 |
| GPT-2 | 15B, 20B, 30B, 40B | 8192 | 18, 24, 36, 50 | 64 |
| OPT | 30B | 7168 | 48 | 56 |
| LLaMA | 34B | 8192 | 48 | 64 |

Testbed. The performance of ProTrain was evaluated in two different experimental environments: (1) 1 node of 4 NVIDIA GeForce RTX 3090 24 GB with 384 GB of DRAM; and (2) 1 node of 4 NVIDIA A100 SXM4 80 GB with NVLink 3.0 with 1 TB of DRAM. The hardware configuration for the 4×RTX 3090 system contained four NVIDIA GeForce RTX 3090 GPUs with 24 GB memory. It is powered by Intel® Xeon® Silver 4214R CPU @2.40 GHz with 24 cores. The CPU DRAM size is 384 GB. The PCIe version is 3 with 15.8 GB/s bandwidth. NVLink is not available in this setup. The hardware configuration for the 4×A100 system contains four NVIDIA A100 GPUs with 80 GB memory. It is powered by Intel® Xeon® Platinum 8480+ with 112 cores. The CPU DRAM size is 1 TB. The PCIe version is 4 with 31.5 GB/s bandwidth. GPUs are fully connected by NVLink 3.0 with 300 GB/s bandwidth.

Baselines. ProTrain was compared with three representative open-source LLM training solutions: (1) FSDP, the native PyTorch support for the ZeRO-3 technique; (2) DeepSpeed, a widely-used distributed training framework that employs ZeRO and offloading techniques, tested with ZeRO-3 for a fair comparison; and (3) Colossal-AI, which adopts chunk-based memory management compatible with the ZeRO-3 technique. For the experiments, DeepSpeed-0.12.1 was utilized, enabling ZeRO-3 alongside offloading of both parameters and optimizer states. The configuration was fine-tuned for optimal performance, with key settings including stage3_max_live_parameter, stage3_max_reuse_distance, stage3_prefetch_bucket_size and reduce_bucket_size. In the case of Colossal-AI, version 0.3.3 was leveraged along with the Gemini Plugin to facilitate chunk-based memory management. This setup featured a static placement policy and also enabled offloading of parameters and optimizer states to make large model trainable. For Fully Sharded Data Parallel (FSDP) which is integrated within PyTorch-2.0.1, the transformer_auto_wrap_policy was employed to ensure that each transformer block was encapsulated within a single FlatParameter. CPU offloading was also enabled to accommodate the training of larger models.

### Experimental Results

Model Scale. The table below reports the maximum trainable model sizes for different frameworks. ProTrain demonstrates superior performance, supporting models up to 30 billion parameters on a single RTX 3090 GPU and maintaining this capability across four GPUs. On the more powerful A100 GPU, ProTrain handles models up to 70 billion parameters, outperforming Colossal-AI and DeepSpeed by 1.75× and 2.06×, respectively, in both single and four-GPU configurations. Additionally, the table shows that FSDP significantly underperforms with fewer GPUs, only managing to train a fraction of the model sizes that ProTrain can accommodate. These results highlight ProTrain's efficient utilization of heterogeneous memory resources across diverse hardware environments, democratizing the large language model training.

Maximum Trainable Model Size (Unit: Billion)

| Backend | RTX 3090*1 | RTX 3090*4 | A100*1 | A100*4 |
|---|---|---|---|---|
| ProTrain | 30B | 30B | 70B | 70B |
| DeepSpeed | 15B | 15B | 34B | 34B |
| Colossal-AI | 25B | 25B | 40B | 40B |
| FSDP | 1B | 15B | 10B | 40B |

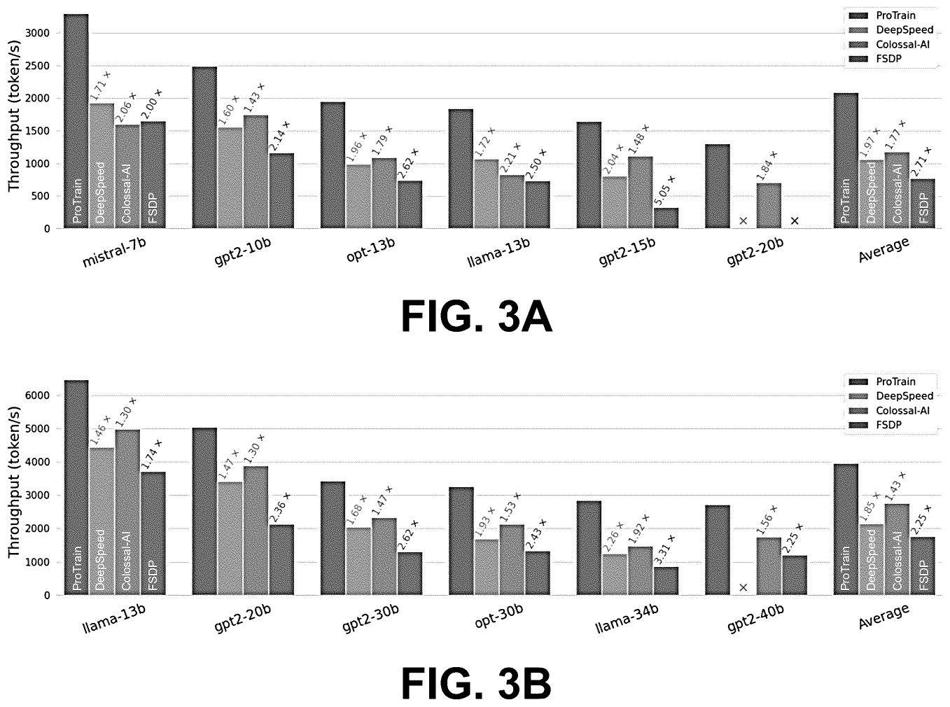

Training Throughput. FIGS. 3A and 3B present the maximum training throughput for various models on four RTX 3090 and A100 GPUs, respectively, measured in tokens per second. The throughput was obtained by testing each model at different batch sizes to find the highest achievable throughput. The notation “×” indicates a failure to train due to an out of memory condition. The results show that ProTrain consistently outperforms other frameworks across diverse hardware and model configurations. On the RTX 3090 GPUs of FIG. 3A, ProTrain achieved an average throughput of 2089.50 tokens per second, approximately 1.77× to 2.71× higher than the other frameworks. On the A100 GPUs of FIG. 3B, ProTrain improved over the throughput of DeepSpeed, Colossal-AI, and FSDP by 1.85×, 1.43×, and 2.25×, respectively.

As model sizes increase, the demand for memory resources grows, resulting in decreased training performance. However, ProTrain consistently maintains robust performance compared to other frameworks. Notably, ProTrain delivers substantial speedups, achieving 5.05× the training speed of 15B GPT-2 on RTX 3090 GPUs and 3.31× of 34B LLaMA on A100 GPUs, compared to FSDP. In such cases, other frameworks either fail to train larger models with feasible batch sizes or resort to inefficient data offloading. Overall, ProTrain offers significant performance advantages, achieving up to 2.71× the throughput of other frameworks, thereby enhancing the efficiency of large model training.

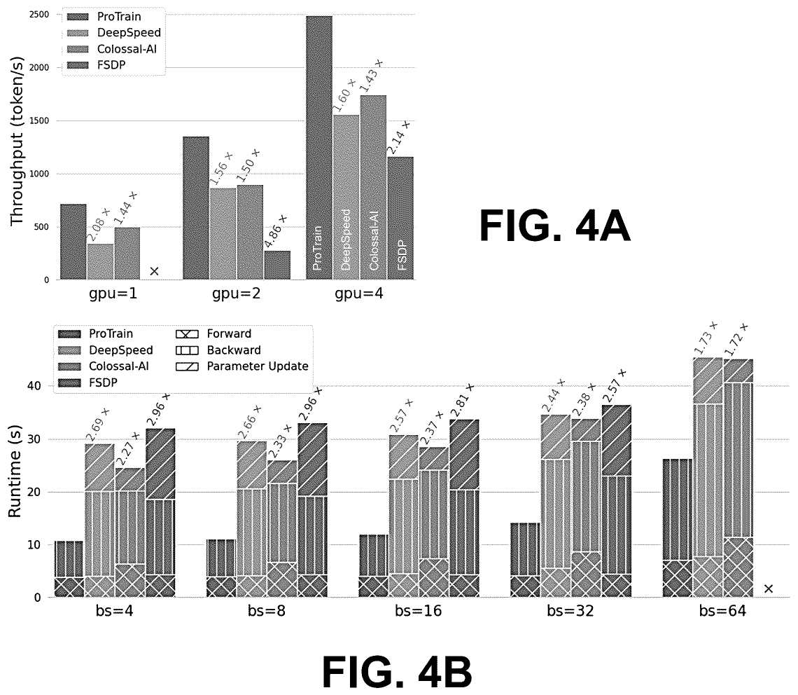

Performance Scalability. FIG. 4A shows the maximum throughput of 10B GPT-2 across varying GPU counts. ProTrain demonstrates impressive scalability, reaching 2493 token/s with four GPUs, a 3.5× increase from a single GPU setup. In contrast, while DeepSpeed and Colossal-AI also increase throughput with more GPUs, their performance gains do not match those of ProTrain. Overall, the results indicate that ProTrain scales effectively as the number of GPUs increases, efficiently leveraging additional hardware to enhance performance.

FIG. 4B provides a detailed breakdown of one iteration time into forward, backward, and parameter update phases for training 10B GPT-2 across varying batch sizes on four RTX 3090 GPUs. At smaller batch sizes where GPU memory pressure is lower, ProTrain significantly outperforms other frameworks for two reasons. First, ProTrain optimizes both computations and 10 through overlapping, effectively hiding much of the latency. As shown in the figure, ProTrain's parameter update time is negligible compared to other phases, benefiting from effective overlap with backward computations. Second, the adaptive memory management identifies the optimal combination of memory-saving techniques, effectively balancing memory usage and performance, resulting in significant improvements. As batch sizes increase, the runtime for one iteration generally rises across all frameworks due to heavier computational and memory demands. In these scenarios, ProTrain maximizes memory-saving techniques, with performance gains primarily driven by better overlapping strategies.

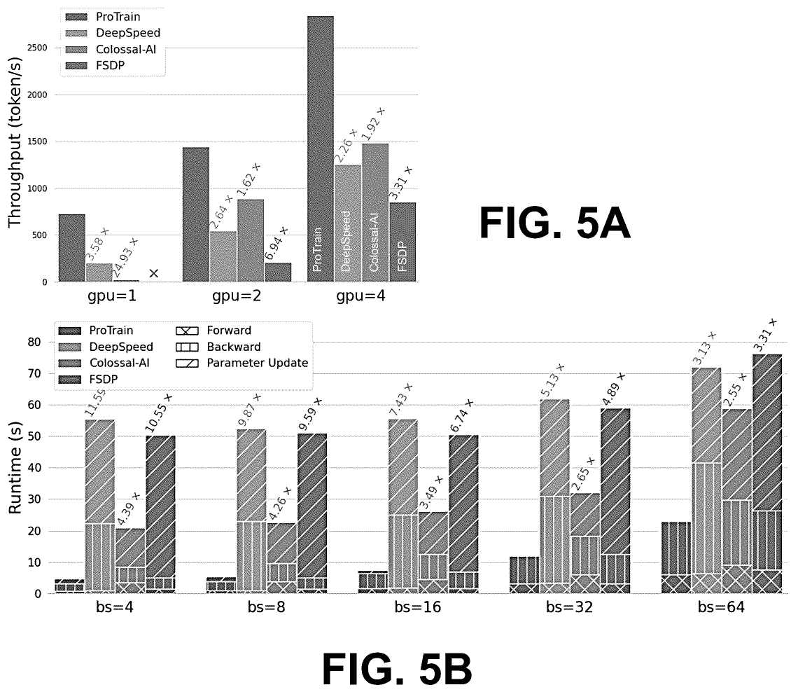

FIGS. 5A and 5B present the scalability performance of ProTrain for LLaMA 34B on four A100 GPUs compared to other frameworks. Similar to the results on RTX 3090 GPUs, ProTrain demonstrates superior scalability, achieving the best performance across all configurations. FIG. 5A shows the maximum throughput across varying GPU counts. FIG. 5B highlights the effectiveness of parameter update overlapping. While DeepSpeed and FSDP offload all parameter updates to the CPU, resulting in higher costs, ProTrain keeps some updates on the GPU and overlaps CPU updates with backward execution. This approach significantly reduces the overall iteration time compared to other frameworks.

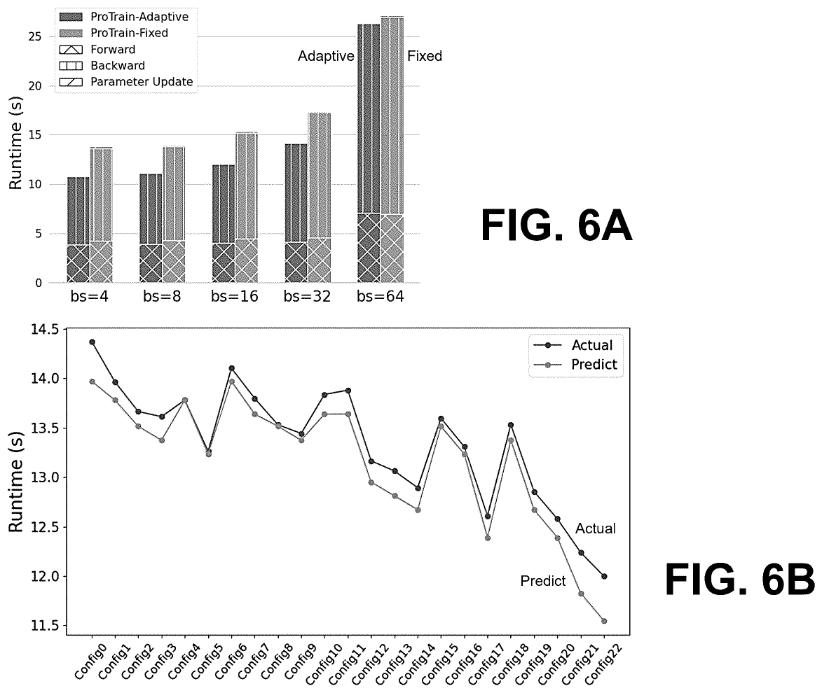

Effect of Adaptive Memory Management. FIG. 6A compares the runtimes of training 10B GPT-2 on four RTX 3090 GPUs using ProTrain's adaptive and fixed configurations. The fixed configuration applies gradient checkpointing to all transformer blocks, utilizes only three chunk buffers, and prevents the use of persistent chunks and swapping blocks. In contrast, the adaptive configuration dynamically adjusts the number of swapping and checkpointing blocks, as well as the number of persistent chunks and chunk buffers according to model and hardware specifics. The results show that the adaptive configuration generally achieves lower runtimes than the fixed setup, especially at smaller batch sizes where memory is less constrained and more adaptable strategies can significantly enhance performance. As batch sizes increase and memory becomes a bottleneck, the adaptive configuration tends to converge towards the fixed configuration.

FIG. 6B shows the runtime differences between actual and predicted outcomes for various configurations during the training of 10B GPT-2. The close alignment between ProTrain's predicted and actual runtimes demonstrates the accuracy of its runtime estimator, proving its effectiveness in identifying a memory-efficient configuration that minimizes runtime for specific model and hardware setups. With this accurate runtime estimator, ProTrain achieves a better balance between memory consumption and runtime overhead, resulting in improved performance.

Training Throughput with and without Offloading. Although ProTrain is designed for scenarios where the model cannot fully fit into GPU memory (requiring offloading), it also delivers excellent performance compared to baselines in non-offloading scenarios. As shown in the table below, when DeepSpeed and Colossal-AI operate without offloading, their training throughput improves for smaller models. However, as the model size increases, the batch size that can be trained without offloading decreases, diminishing the performance advantage. For instance, Colossal-AI's performance on LLaMA 13B is 15% slower without offloading compared to with offloading. Overall, regardless of whether the baselines use offloading or not, ProTrain consistently achieves the best performance, showing its versatility and adaptability across different training scenarios.

Maximum Training Throughput on four A100
GPUs w/and w/o Offloading (Unit: token/s)

| | | Mistral | GPT-2 | LLaMA | GPT-2 |
|---|---|---|---|---|---|
| Model | | 7B | 10B | 13B | 20B |
| ProTrain | adaptive | 11060.92 | 8266.40 | 6471.32 | 5043.75 |
| DeepSpeed | w/ | 7708.30 | 6447.70 | 4446.43 | 3420.90 |
| | | (1.43x) | (1.28x) | (1.46x) | (1.47x) |
| | w/o | 9748.03 | 7320.50 | 5234.92 | OOM |
| | | (1.13x) | (1.13x) | (1.24x) | |
| Colossal-AI | w/ | 7279.76 | 6848.47 | 4980.91 | 3892.95 |
| | | (1.52x) | (1.21x) | (1.30x) | (1.30x) |
| | w/o | 8447.30 | 7855.46 | 4404.30 | 2084.74 |
| | | (1.31x) | (1.05x) | (1.47x) | (2.42x) |
| FSDP | w/ | 5315.81 | 4666.03 | 3715.12 | 2136.16 |
| | | (2.08x) | (1.77x) | (1.74x) | (2.36x) |
| | w/o | OOM | OOM | OOM | OOM |

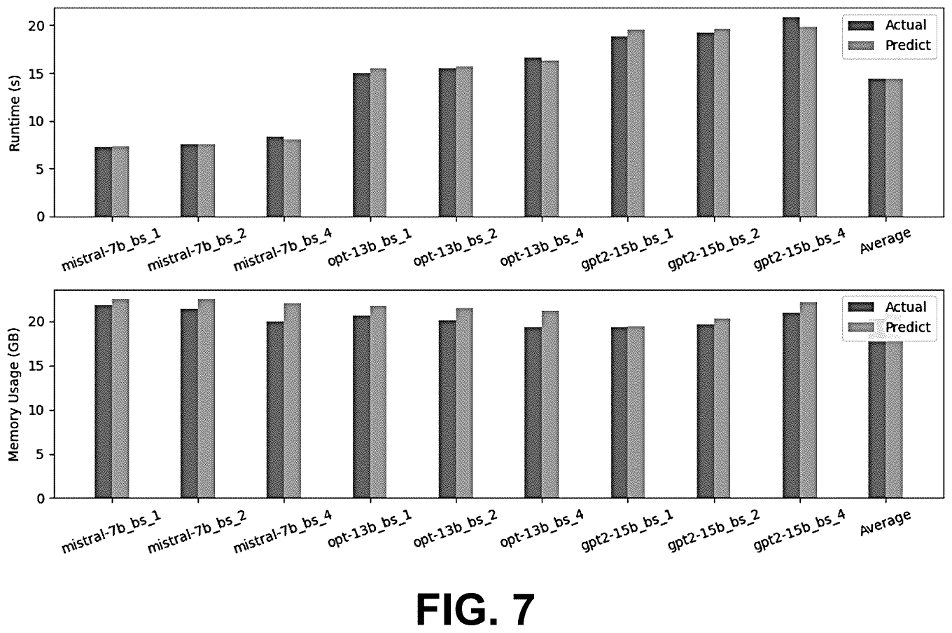

Effect of Runtime/Peak Memory Usage Estimator. FIG. 7 compares predicted versus actual runtime and peak memory usage using ProTrain's chosen configuration on four RTX 3090 GPUs. The top bar chart shows the runtime prediction error does not exceed 5%, reflecting the high accuracy of the runtime estimator across different models and batch sizes. The bottom bar chart compares the predicted and actual peak memory usage, measured using max_memory_allocated. Prediction error increases slightly with larger batch sizes, typically overestimating by no more than 10%. This conservative estimation helps mitigate the risk of out-of-memory errors by accounting for memory fragmentation, thus ensuring reliable performance in diverse training conditions. Overall, these results validate ProTrain's estimators for both runtime and memory, confirming their reliability in adaptive memory management.

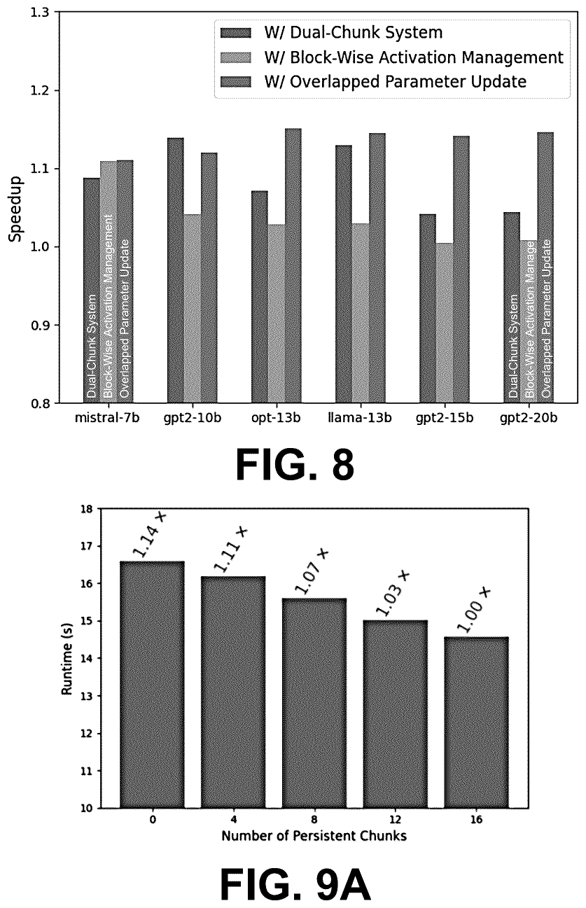

Ablation Study. The performance impacts of various techniques were evaluated, and the speedup of different techniques shown in FIG. 8. Dual-chunk system: ProTrain achieves 4-14% speedup when using persistent chunks and a persistent-chunk-first strategy. Block-wise activation management: compared to systems that apply gradient checkpointing to all blocks, ProTrain's block-wise management enhances performance by 1-11%. Overlapped parameter updates: ProTrain delivers a 13.6% speedup on average.

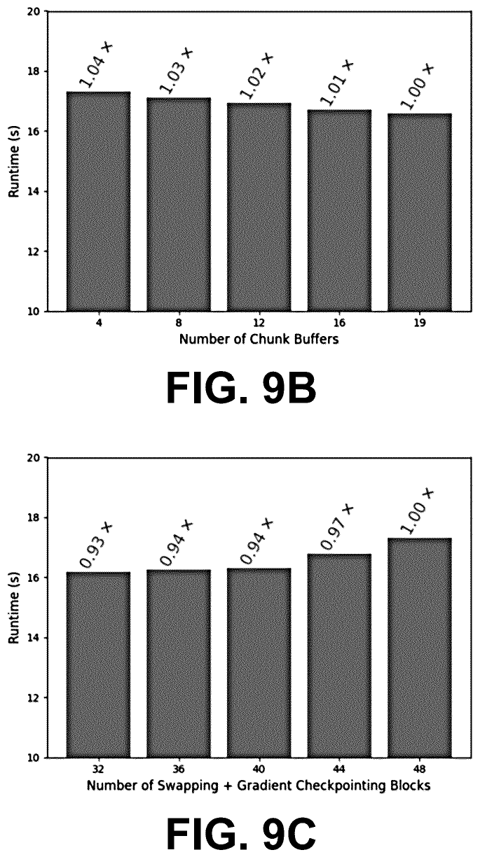

FIGS. 9A-9C shows the speed up of different configurations. As shown in FIGS. 9A and 9B, increasing persistent chunks from 0 to 16 and chunk buffers from 4 to 19 improves training throughput by 1.14× and 1.04× with a sacrifice in 1.77× and 1.92× higher peak memory consumption, respectively. As shown in FIG. 9C, adding more blocks with swapping or checkpointing from 32 to 48 brings 3.68× memory savings but reduces the performance by 0.93×. This indicates the importance of tuning these configurations to optimize training performance while meeting memory constraints. This trend is consistent across all models and hardware types. However, the specific configuration that most significantly impacts performance varies depending on the model and hardware. In FIGS. 9A-9C, the advantages of persistent chunks are prominent, leading ProTrain to maximize their use in configuration search.

In this disclosure, a novel training system is designed to coordinate memory, computation, and 10 effortlessly. ProTrain simplifies the training process through adaptive memory management, enabling users to achieve up to 5× the speed of existing state-of-the-art frameworks without manual intervention. Importantly, ProTrain empowers the training of models with up to 70 billion parameters on a single A100 GPU.

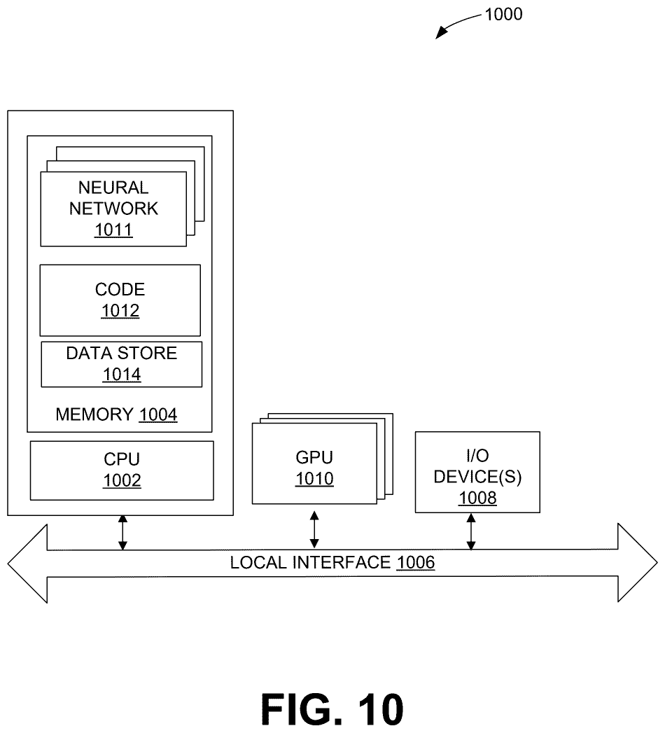

Next, FIG. 10 depicts a schematic block diagram of one or more computing device(s) 1000 that can be used to implement various embodiments of the present disclosure. An exemplary computing device 1000 includes at least one processor circuit, for example, having a processor (or Central Processing Unit—CPU) 1002 and a memory 1004, both of which are coupled to a local interface 1006, and one or more input and output (I/O) devices 1008. The local interface 1006 may comprise, for example, a data bus with an accompanying address/control bus or other bus structure as can be appreciated. The computing device 1000 further includes Graphical Processing Unit(s) (GPU) 1010 that are coupled to the local interface 1006 and may utilize memory 1004 and/or may have its own dedicated memory. The processor (CPU) 1002 and/or GPU(s) 1010 can perform various operations such as image enhancement, graphics rendering, image/video processing, recognition (e.g., text recognition, object recognition, feature recognition, etc.), image stabilization, machine learning, filtering, image classification, and any of the various operations described herein.

Stored in the memory 1004 are both data and several components that are executable by the processor (CPU) 1002. In particular, stored in the memory 1004 and executable by the processor (CPU) 1002 are code for implementing one or more neural networks 1011 (e.g., artificial and/or convolutional neural network models) and code 1012 for using the neural network models 1011 for training Large Language Models (LLMs). More specifically, the code 1012 may be computer readable instructions, stored on a computer readable media, such as a magnetic, optical, magneto-optical, holographic, integrated circuit, or other form of non-volatile memory. The instructions may be coded, for example, using C, C++, JAVA, SAS or other programming or scripting language. To be executed, the respective computer readable instructions are loaded into RAM associated with the computing device 1000. Also stored in the memory 1004 may be a data store 1014 and other data. The data store 1014 can include an electronic repository or database relevant to, e.g., computable records of LLMs and data analysis. In addition, an operating system may be stored in the memory 1004 and executable by the processor (CPU) 1002. The I/O devices 1008 may include input devices, for example but not limited to, a keyboard, mouse, etc. Furthermore, the I/O devices 1008 may also include output devices, for example but not limited to, a printer, display, etc.

A number of software components are stored in the memory 1004 and are executable by the processor (CPU) 1002. In this respect, the term “executable” means a program or application file that is in a form that can ultimately be run by the processor (CPU) 1002. Examples of executable programs may be, for example, a compiled program that can be translated into machine code in a format that can be loaded into a random access portion of the memory 1004 and run by the processor (CPU) 1002, source code that may be expressed in proper format such as object code that is capable of being loaded into a random access portion of the memory 1004 and executed by the processor (CPU) 1002, or source code that may be interpreted by another executable program to generate instructions in a random access portion of the memory 1004 to be executed by the processor (CPU) 1002, etc. An executable program may be stored in any portion or component of the memory 1004 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1004 is defined herein as including both volatile and nonvolatile memory and data storage components. Volatile components are those that do not retain data values upon loss of power. Nonvolatile components are those that retain data upon a loss of power. Thus, the memory 1004 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor (CPU) 1002 may represent multiple processors (CPUs) 1002 and/or multiple processor cores and the memory 1004 may represent multiple memories 1004 that operate in parallel processing circuits, respectively, such as multicore systems, FPGAs, GPUs, GPGPUs, spatially distributed computing systems (e.g., connected via the cloud and/or Internet). In such a case, the local interface 1006 may be an appropriate network that facilitates communication between any two of the multiple processors (CPUs) 1002, between any processor (CPU) 1002 and any of the memories 1004, or between any two of the memories 1004, etc. The local interface 1006 may comprise additional systems designed to coordinate this communication, including, for example, performing load balancing. The processor (CPU) 1002 may be of electrical or of some other available construction.

Although the adaptive memory management and other applications/programs described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the adaptive memory management and other applications/programs, that comprises software or code can be embodied in any non-transitory computer-readable medium for use by or in connection with an instruction execution system such as, for example, a processor (CPU) 1002 in a computer system or other system. In this sense, the logic may comprise, for example, statements including instructions and declarations that can be fetched from the computer-readable medium and executed by the instruction execution system. In the context of the present disclosure, a “computer-readable medium” can be any non-transitory medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the adaptive memory management and other applications/programs, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 1000, or in multiple computing devices in the same computing environment. Additionally, it is understood that terms such as “application,” “service,” “system,” “engine,” “module,” and so on may be interchangeable and are not intended to be limiting.

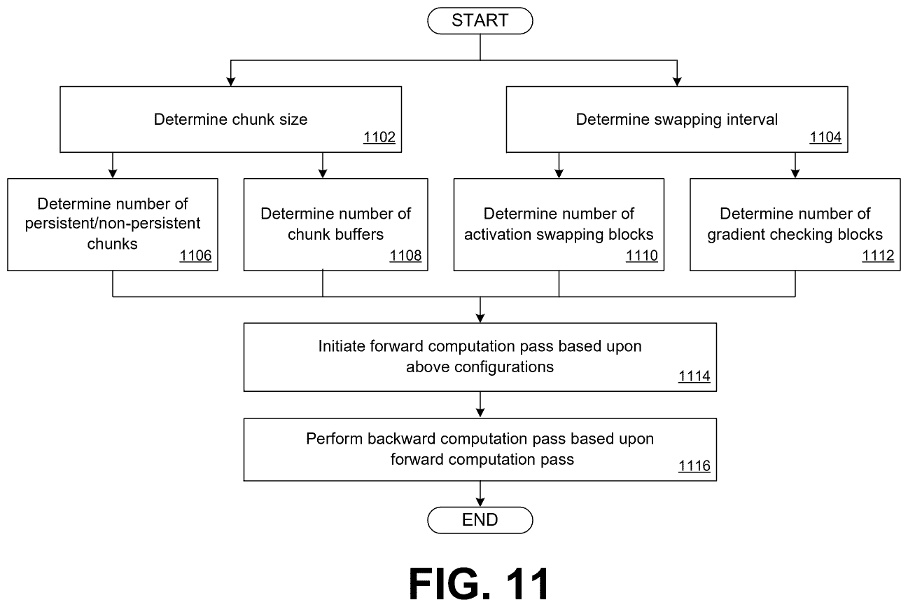

FIG. 11 is a flow diagram that illustrates an example of adaptive memory management that can be implemented by the computing device(s) of FIG. 10. Beginning at 1102, a chunk size can be determined. The chunk size can be determined by organizing parameters according to their execution order and selecting the size that minimizes memory waste. In parallel, a swapping interval can be determined at 1104. The swapping interval can comprise one activation swapping block followed by an integer number of gradient checkpointing blocks. The swapping interval can be determined by dividing the time required to swap one transformer block by the computation time of the one transformer block. Based on the determined chunk size and swapping interval, a number of further configurations can be established, including determining at 1106 the number of persistent chunks and non-persistent chunks to offload model states from the GPUs 1010 (FIG. 10), determining at 1108 the number of chunk buffers on the GPUs 1010 for prefetching and reusing the model states, determining at 1110 the number of activation swapping blocks to offload activations from the GPUs 1010, and determining at 1112 the number of transformer blocks to apply gradient checkpointing.

At 1114, a forward computation pass based upon the above configurations can be initiated. The forward computation pass can comprise a plurality of swapping intervals thereby providing interleaved activation swapping and gradient checkpointing. The forward computation pass can be completed by a series of transformer blocks without optimization. A backward computation pass can be performed at 1116, following the forward computation pass, based upon the forward computation pass.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for adaptive memory management, comprising:
determining a chunk size for organizing parameters, the chunk size determined based on execution order of parameters and selected to reduce memory waste;
determining a swapping interval comprising one activation swapping block followed by an integer number of gradient checkpointing blocks, the swapping interval determined by dividing a time required to swap one transformer block by a computation time of the one transformer block;
determining a number of persistent chunks and non-persistent chunks to offload model states from graphics processing units (GPUs);
determining a number of chunk buffers on the GPUs for prefetching and reusing the model states;
determining a number of activation swapping blocks to offload activations from the GPUs;
determining a number of transformer blocks to apply gradient checkpointing; and
initiating a forward computation pass based upon the swapping interval, the number of persistent chunks and non-persistent chunks to offload, the number of chunk buffers, the number of activation swapping blocks and the number of transformer blocks.

2. The method of claim 1, wherein the forward computation pass comprises a plurality of swapping intervals thereby providing interleaved activation swapping and gradient checkpointing.

3. The method of claim 2, wherein the forward computation pass is completed by a series of transformer blocks without optimization.

4. The method of claim 1, further comprising performing a backward computation pass following the forward computation pass, the backward computation pass based upon the forward computation pass.

5. The method of claim 1, comprising updating parameters of the model states on one or more of the GPUs, a central processing unit (CPU), or a combination of both.

6. The method of claim 1, comprising determining a complete parameter chunk based on shards collected from the GPUs for determination of the number of persistent chunks.

7. The method of claim 6, comprising uploading parameter chunks that are non-persistent chunks to the GPUs from a central processing unit (CPU) before collecting the shards.

8. The method of claim 7, comprising:
storing computed gradients in the parameter chunks on the GPUs during the backward computation pass;
performing a gradient reduction by averaging computed gradients across the GPUs; and
offloading gradient chunks that are non-persistent chunks from the GPUs to the CPU after gradient reduction.

9. The method of claim 7, wherein the parameter chunks comprise persistent chunks permanently storing model states on the GPUs and non-persistent chunks storing model states on the CPU with parameters uploaded to the GPUs.

10. The method of claim 1, comprising monitoring memory changes and peak memory usage based upon hooks before and during operations.

11. The method of claim 10, comprising predicting memory demand based at least in part upon monitored memory changes and peak memory usage.

12. The method of claim 10, comprising providing an accurate runtime estimation for a given configuration based upon monitored memory changes and peak usage.

13. The method of claim 12, wherein the hooks of hookable operations are monitored for memory changes before and during operations.

14. A system for adaptive memory management, comprising:
a computing system comprising processing circuitry including a central processing unit (CPU), graphics processing units (GPUs), and memory;
adaptive memory management executable by the computing system, the adaptive memory management configured to, when executed by the computing system, at least:
determine a chunk size for organizing parameters, the chunk size determined based on execution order of parameters and selected to reduce memory waste;
determine a swapping interval comprising one activation swapping block followed by an integer number of gradient checkpointing blocks, the swapping interval determined by dividing a time required to swap one transformer block by a computation time of the one transformer block;
determine a number of persistent chunks and non-persistent chunks to offload model states from the GPUs;
determine a number of chunk buffers on the GPUs for prefetching and reusing the model states;
determine a number of activation swapping blocks to offload activations from the GPUs;
determine a number of transformer blocks to apply gradient checkpointing; and
initiate a forward computation pass based upon the swapping interval, the number of persistent chunks and non-persistent chunks to offload, the number of chunk buffers, the number of activation swapping blocks and the number of transformer blocks.

15. The system of claim 14, wherein the forward computation pass comprises a plurality of swapping intervals thereby providing interleaved activation swapping and gradient checkpointing.

16. The system of claim 15, wherein the forward computation pass is completed by a series of transformer blocks without optimization.

17. The system of claim 14, wherein the adaptive memory management is further configured to perform a backward computation pass following the forward computation pass, the backward computation pass based upon the forward computation pass.

18. The system of claim 14, wherein the adaptive memory management is further configured to update parameters of the model states on one or more of the GPUs, the CPU, or a combination of both.

19. The system of claim 14, wherein the adaptive memory management is further configured to determine a complete parameter chunk based on shards collected from the GPUs for determination of the number of persistent chunks.

20. The system of claim 14, wherein the adaptive memory management is further configured to monitor memory changes and peak memory usage based upon hooks before and during operations.
